(19) United States
(12) Patent Application Publication
(10) Pub. No.: US 2017/0321473 A1
(43) Pub. Date: Nov. 9, 2017

(54) SPACER FOR INSULATING GLAZING UNITS

(71) Applicant: SAINT-GOBAIN GLASS FRANCE, Courbevoie (FR)

(72) Inventors: Katrin FRANK, LEONBERG (DE); Walter SCHREIBER, AACHEN (DE); Erol Ertugrul SACU, STOLBERG (DE); Daniel SUTER, JONA (CH); Thomas UHLEMANN, KONSTANZ (DE); Damir PLUSKO, KREUZLINGEN (CH)

(21) Appl. No.: 15/531,728

(22) PCT Filed: Dec. 1, 2015
(86) PCT No.: PCT/EP2015/078144

§ 371 Date: May 30, 2017

(30) Foreign Application Priority Data
Dec. 8, 2014 (EP) 14196698.6

(51) Int. Cl. E06B 3/663; B32B 17/10; C03C 27/10; B32B 37/10; E06B 3/673

(52) U.S. Cl. CPC E06B 3/66366; E06B 3/67326; E06B 3/66352; E06B 3/66347; E06B 3/66328; B32B 17/10302; C03C 27/10; B32B 37/10; B32B 17/10816; B32B 2315/08

(57) ABSTRACT

A spacer for insulating glazing units is presented. The spacer has a polymeric main body with features that include a first pane contact surface, a second pane contact surface, a first glazing interior surface, a second glazing interior surface, an outer surface, a first hollow chamber, and a second hollow chamber. A groove to accommodate a pane is formed between the first glazing interior surface and the second glazing interior surface, with the first hollow chamber being adjacent the first glazing interior surface and the second hollow chamber being adjacent the second glazing interior surface. Lateral flanks of the groove are formed by walls of the first and second hollow chambers.

The invention relates to a spacer for insulating glazing units, an insulating glazing unit, a method for production thereof, and use thereof.

The thermal conductivity of glass is lower by roughly a factor of 2 to 3 than that of concrete or similar building materials. However, since, in most cases, panes are designed significantly thinner than comparable elements made of brick or concrete, buildings frequently lose the greatest share of heat via external glazing. The increased costs necessary for heating and air-conditioning systems make up a part of the maintenance costs of the building that must not be underestimated. Moreover, as a consequence of more stringent construction regulations, lower carbon dioxide emissions are required. Triple insulating glazing units, without which, primarily as a result of increasingly rapidly rising prices of raw materials and more stringent environmental protection constraints, it is no longer possible to imagine the building construction sector, are an important approach to a solution for this. Consequently, triple insulating glazing units constitute an increasingly greater part of the outward directed glazing units.

Triple insulating glazing units usually include three panes made of glass or polymeric materials that are separated from one another by two individual spacers. A further pane is placed on a double glazing unit using an additional spacer. During assembly of such a triple glazing unit, very small tolerance specifications apply since the two spacers must be installed at exactly the same height. Thus, compared to double glazing units, the assembly of triple glazing units is significantly more complex since either additional system components must be provided for the assembly of another pane or a time-consuming multiple pass through a conventional system is necessary The thermal insulation capacity of triple-insulating glass is, compared to single or double glazings, significantly higher. With special coatings, such as low-E coatings, this can be further increased and improved. So-called low-E coatings offer an effective capability of screening out infrared radiation already before entry into the living space and, at the same time, of letting daylight pass through. Low-E coatings are thermal radiation reflecting coatings that reflect a significant portion of the infrared radiation, which, in the summer, results in reduced warming of the living space. Various low-E coatings are, for example, known from DE 10 2009 006 062 A1, WO 2007/101964 A1, EP 0 912 455 B1, DE 199 27 683 C1, EP 1 218 307 B1, and EP 1 917 222 B1. Such low-E coatings cannot be applied to the middle pane of a triple-glazing unit according to the prior art since the coating causes heating of the pane under sunlight that results in a failure of the adhesive bond between the middle pane and the spacers. Moreover, adhesive bonding of the middle pane to a functional coating generates additional stresses. To compensate these stresses, the middle pane according to the prior art must be prestressed.

EP 0 852 280 A1 discloses a spacer for double insulating glazing units. The spacer includes a metal foil on the adhesion surface and glass fiber content in the plastic of the main body. Such spacers are also frequently used in triple insulating glazing units, wherein a first spacer is mounted between a first outer pane and the inner pane, and a second spacer is mounted between a second outer pane and the inner pane. Here, the two spacers must be installed congruently to ensure a visually appealing appearance.

WO 2010/115456 A1 discloses a hollow profile spacer with a plurality of hollow chambers for multiple glass panes comprising two outer panes and one or a plurality of middle panes that are installed in a groove-shaped accommodating profile. Here, the spacer can be manufactured both from polymeric materials as well as being made of rigid materials, such as stainless steel or aluminum.

DE 10 2009 057 156 A1 describes a triple insulating glazing unit that includes a shear-resistant spacer that is bonded in a shear-resistant manner to the two outer panes with a high-tensile adhesive. The spacer has a groove, in which the middle pane of the triple insulating glazing unit is inserted.

The spacers described in WO 2010/115456 A1 and in DE 10 2009 057 156 A1, which can accommodate a third pane in a groove, have the advantage that only a single spacer has to be installed and, thus, the step of the alignment of two individual spacers in the prior art triple glazing unit is eliminated. However, in the production of an insulating glazing unit using such spacers, which accommodate a third pane in a groove, the following problem occurs: As described in WO 2010/115456, the middle pane is pre-mounted in the groove of the spacer, and this spacer frame is glued between the two outer glazings using a sealant. The spacer frame with an integrated middle pane is held in position during this period by the adhesive bond between the spacer and the outer glazings. With the spacer frames customary in the trade without an integrated glass pane, this adhesive bond suffices. In contrast, the adhesive bond with a spacer with an integrated middle pane fails due to the additional weight of the integrated pane, and the spacer frame sags downward during production of the insulating glazing. In order to prevent sagging of the middle glazing, the frame must be additionally supported during the process, rendering the assembly of the insulating glazing significantly more difficult. In the following step, an outer seal is installed and the glazing is placed on a frame to dry. The material of the outer seal is initially soft and only hardens over a period of typically a few hours. Especially with large, heavy panes, a slippage of the spacer frame with a middle glazing still occurs even in this stage since the sealing compound is still soft and can be displaced.

The object of the present invention is to provide a spacer for insulating glazing units, which enables simplified and improved assembly of the insulating glazing unit, an insulating glazing unit as well as an economical method for assembling an insulating glazing unit with a spacer according to the invention.

The object of the present invention is accomplished according to the invention by a spacer for insulating glazing units according to the independent claim 1. Preferred embodiments of the invention are apparent from the subclaims.

The spacer according to the invention for insulating glazing units comprises at least a polymeric main body, which has a first pane contact surface and a second pane contact surface running parallel thereto, a first glazing interior surface, a second glazing interior surface, and an outer surface. The polymeric main body has a wall thickness d. A first hollow chamber and a second hollow chamber as well as a groove are introduced into the polymeric main body. The groove runs parallel to the first pane contact surface and the second pane contact surface and serves to accommodate a pane. The first hollow chamber is adjacent the first glazing interior surface, while the second hollow chamber is adjacent the second glazing interior surface, with the glazing interior surfaces situated above the hollow chambers and the outer surface situated below the hollow chambers. In this context, “above” is defined as turned toward the pane interior of an insulating glazing unit with a spacer according to the invention, and “below” is defined as turned away from the pane interior. Since the groove runs between the first glazing interior surface and the second glazing interior surface, it laterally delimits them and separates the first hollow chamber and the second hollow chamber from one another. The lateral flanks of the groove are formed by the walls of the first hollow chamber and the second hollow chamber. The groove forms an indentation that is suitable to accommodate the middle pane (third pane) of an insulating glazing unit. Thus, the position of the third pane is fixed by two lateral flanks of the groove as well as the bottom surface of the groove. A web is mounted on the side of the spacer according to the invention opposite the groove. The web is thus situated on the side of the spacer according to the invention which is opposite the bottom surface of the groove. The web is situated directly below the groove since, then, particularly good stabilization of the third pane is achieved. The web serves to support the spacer frame with an integrated middle glazing during production of the insulating glass pane and, hence, to prevent sagging of the spacer frame.

Thus, the invention makes available a doubled spacer (“double spacer”) that enables simplified and precise assembly in a triple insulating glazing unit. Here, the two outer panes (first pane and second pane) are installed on the pane contact surfaces, whereas the middle pane (third pane) is inserted into the groove. Since the polymeric main body is formed as a hollow profile, the lateral flanks of the hollow chambers are flexible enough, on the one hand, to yield at the time of insertion of the pane into the groove and, on the other, to fix the pane tension-free. The web mounted below the groove serves to support the spacer frame with an integrated third pane after the adhesive bonding of the first and second pane to the pane contact surfaces. Thus, slippage of the spacer frame before and after pressing or during the curing of the outer seal is prevented. The spacer according to the invention thus enables simplified yet precisely fitting assembly of the triple glazing unit. With the use of the double spacer with the web according to the invention, sagging of the spacer frame with a middle glass, as would occur with the previously described spacers according to the prior art, is impossible. Moreover, the fixing of the third pane according to the invention is done by a groove with flexible lateral flanks and not by an adhesive bond. Thus, the spacer according to the invention enables the production of a triple glazing unit with a low-E coating on the third pane, without prestressing of the third pane being necessary. With adhesive bonding or with an otherwise rigid locking of the pane, the heating of the pane caused by the low-E coating would favor a failure of the adhesive bond. Furthermore, prestressing of the third pane would be necessary to compensate for stresses occurring. However, with the use of the spacer according to the invention, the prestressing process is eliminated, by which means a further cost reduction can be achieved. By means of the tension-free fixing in a groove according to the invention, the thickness and, hence, the weight of the third pane can also be advantageously reduced.

Preferably, the bottom surface of the groove is directly adjacent the outer surface of the polymeric main body, without one or both hollow chambers extending below the groove. Thus, the greatest possible depth of the groove is obtained, with the surface of the lateral flanks maximized for stabilization of the pane.

The hollow chambers of the spacer according to the invention contribute not only to the flexibility of the lateral flanks but, furthermore, result in a weight reduction compared to a solidly formed spacer and can be available to accommodate other components, for example, a desiccant.

The first pane contact surface and the second pane contact surface constitute the sides of the spacer onto which, at the time of incorporation of the spacer, the assembly of the outer panes (first pane and second pane) of an insulating glazing unit is done. The first pane contact surface and the second pane contact surface run parallel to one another.

The glazing interior surfaces are defined as the surfaces of the polymeric main body that face in the direction of the interior of the glazing unit after incorporation of the spacer in an insulating glazing unit. The first glazing interior surface is between the first and the third pane, whereas the second glazing interior surface is arranged between the third and the second pane.

The outer surface of the polymeric main body is the side opposite the glazing interior surfaces that points away from the interior of the insulating glazing unit in the direction of an outer insulating layer. The outer surface preferably runs perpendicular to the pane contact surfaces. Alternatively, the section of the outer surface nearest the pane contact surfaces can, however, be inclined in the direction of the pane contact surfaces at an angle of preferably 30° to 60° relative to the outer surface. This angled geometry improves the stability of the polymeric main body and enables better adhesive bonding of the spacer according to the invention with a barrier film. A planar outer surface that is perpendicular, in its entire course, to the pane contact surfaces has, in contrast, the advantage that the sealing surface between the spacer and the pane contact surfaces is maximized and simpler shaping makes the production process easier.

In a preferred embodiment, a gas- and vapor-tight barrier is arranged on the outer surface of the polymeric main body and on at least a part of the pane contact surfaces. The web is mounted on the barrier. The gas- and vapor-tight barrier improves the tightness of the spacer against gas loss and penetration of moisture. In this embodiment, the main body and the web are implemented in two pieces. “Two-piece” means that the main body and the web are produced separately in two pieces. The barrier is applied only on the outer surface of the polymeric main body and on a part of the pane contact surfaces, preferably on roughly one half to two thirds of the pane contact surfaces. The web is subsequently glued, plugged, or extruded onto the barrier on the outer surface of the polymeric main body. The web can, in this case, be made of a lower-cost material, which preferably has low thermal conductivity. Compared to a one-piece implementation of the polymeric main body and the web, in which the barrier also encloses the exposed surfaces of the web, material for the barrier coating or the barrier film can be saved. In addition, with the two-piece implementation, the barrier is not exposed, in the finished insulating glazing unit, to any mechanical stresses and is thus protected against damage. In a particularly preferred embodiment, the web is implemented as a T profile. In this case, the web includes two side arms, which are adjacent the barrier. The two side arms contribute to an improvement of the stability of the spacer since the contact area between the web and the barrier is enlarged. The side arms can extend over the entire outer surface of the polymeric main body or cover only a part of the outer surface. Preferably, they cover roughly 40% to 60% of the outer surface. The thickness of the side arms is between 1 mm and 3 mm. With these dimensions, particularly good stability of the web is obtained.

In an alternative advantageous embodiment, the polymeric main body is extruded or coextruded in one piece with the web, by which means a very stable connection between the main body and the web is created. In this embodiment, a gas- and vapor-tight barrier is mounted on the outer surface of the polymeric main body, on at least a part of the pane contact surfaces, on the lateral surfaces of the web, and on the edge of the web. The gas- and vapor-tight barrier improves the tightness of the spacer against gas loss and penetration of moisture. Particularly preferably, the web is made of the same material as the polymeric main body, and the polymeric main body is extruded in one piece with the web, which is advantageous for production and by which means material incompatibilities are avoided. Compared to the previously described embodiment with a subsequently mounted web, a production step is eliminated by the coextrusion of the web and the main body.

The lateral surfaces of the web are the surfaces of the web which, after incorporation of the spacer into an insulating glazing unit, face toward the first pane and toward the second pane and run parallel thereto. The lateral surfaces can alternatively also be inclined in one direction or another. In the finished insulating glazing unit, the lateral surfaces are in contact with the outer seal. The edge of the web refers to the lower surface of the web, which faces away from the pane interior and toward the external environment after installation in an insulating glazing unit. The edge of the web is the transverse surface that connects the two side surfaces of the web. Accordingly, the web comprises three exposed surfaces: two side surfaces and the edge of the web.

In a preferred embodiment, the barrier is implemented as a film. This barrier film includes at least one polymeric layer as well as one metallic layer or one ceramic layer. The layer thickness of the polymeric layer is between 5 μm and 80 μm, whereas metallic layers and/or ceramic layers with a thickness of 10 nm to 200 nm are used. Within the layer thicknesses mentioned, particularly good tightness of the barrier film is obtained.

Particularly preferably, the barrier film includes at least two metallic layers and/or ceramic layers, which are arranged alternatingly with at least one polymeric layer. Preferably, the outward lying layers are formed by the polymeric layer. The alternating layers of the barrier film can be bonded to one another or applied on one another in various methods known in the prior art. Methods for depositing metallic or ceramic layers are well known to the person skilled in the art. The use of a barrier film with an alternating layer sequence is particularly advantageous with regard to the tightness of the system. A defect in one of the layers does not result in a loss of function of the barrier film. By comparison, in the case of a single layer, one small defect can already result in a complete failure. Furthermore, the application of multiple thin layers is advantageous compared to a thick layer since with increasing layer thicknesses, the risk of internal adhesion problems increases. Also, thicker layers have higher conductivity such that such a film is less suitable thermodynamically.

The polymeric layer of the film preferably includes polyethylene terephthalate, ethylene vinyl alcohol, polyvinylidene chloride, polyamides, polyethylene, polypropylene, silicones, acrylonitriles, polyacrylates, polymethyl acrylates, and/or copolymers or mixtures thereof. The metallic layer preferably includes iron, aluminum, silver, copper, gold, chromium, and/or alloys or oxides thereof. The ceramic layer of the film preferably includes silicon oxides and/or silicon nitrides.

The film preferably has gas permeation of less than 0.001 g/(m² h).

The composite comprising a polymeric main body and a film preferably has a PSI value less than (equal to) 0.05 W/mK, particularly preferably less than (equal to) 0.035 W/mK. The barrier film can be applied, for example, glued, on the polymeric main body. Alternatively, the film can be coextruded together with the main body.

When the main body is coextruded with the web, the gas- and vapor-tight barrier is preferably implemented as a coating. This coating includes aluminum, aluminum oxides, and/or silicon oxides and is preferably applied by a PVD method (physical vapor deposition). By this means, the production method can be significantly simplified since the component is provided with the barrier coating directly after extrusion and no separate step is necessary for the application of a film. The coating including aluminum, aluminum oxides, and/or silicon oxides delivers particularly good results in terms of tightness and, in addition, presents excellent adhesion properties relative to the outer seal materials used in insulating glazing units.

The groove corresponds in its width at least to the thickness of the pane to be inserted.

Preferably the groove is wider than the pane mounted therein such that, additionally, an insert that prevents slippage of the pane and development of noise resulting therefrom during opening and closing of the window can be inserted into the groove. Moreover, the insert compensates the thermal expansion of the third pane during heating such that, independently of climatic conditions, stress-free fixing is ensured. Also, the use of an insert is advantageous with regard to minimizing the diversity of variants of the spacer. To keep the diversity of variants as small as possible and, nevertheless, to enable a variable thickness of the middle pane, a spacer can be used with different inserts. Variation of the insert is substantially more economical in terms of production costs than variation of the spacer. The insert preferably contains an elastomer, particularly preferably a butyl rubber.

The Insert is preferably mounted such that the first inner interpane space, which is located between the first pane and the third pane, is connected to the second inner interpane space, which is located between the third pane and the second pane, such that an air or gas exchange is possible. This enables pressure equalization between the inner interpane spaces, which, in comparison with an embodiment with hermetically sealed inner interpane spaces, results in a significant reduction of the climatic loads. In order to enable this pressure equalization, the insert is preferably mounted at intervals in the groove of the polymeric main body. In other words, the Insert is not mounted continuously along the entire spacer profile, but only in individual regions in which the pane is fixed, in order to prevent rattling of the pane in the groove. Pressure equalization can occur in the regions without an insert.

In another preferred embodiment, the spacer according to the invention is mounted in the groove without an insert. Preferably, the wall thickness d′ of the lateral flanks is reduced in comparison with the wall thickness d of the polymeric main body, thus creating increased flexibility of the lateral flanks. When d′ is selected smaller than d, the flexibility of the lateral flanks can be increased such that they compensate thermal expansion of the third pane even without the use of an insert and, and hence, tension-free fixing is always ensured. It has been demonstrated that a wall thickness of the lateral flanks of d′<0.85 d, preferably of d′<0.7 d, particularly preferably of d′<0.5 d, is particularly suitable for this. When no insert is fitted into the groove, the first interpane space and the second interpane space are not air-tightly sealed from one another. This has the advantage that air circulation can be generated, in particular when a pressure equalization system is integrated into the spacer.

In another preferred embodiment, the embodiments described are combined, wherein an insert is used and the wall thickness of the lateral flanks is reduced as well. Thus, compensation of the thermal expansion of the third pane is done both through the flexibility of the lateral flanks and also through the insert. At the same time, the possibility remains of varying the thickness of the third pane to a certain extent and compensating this through the selection of the insert. In an advantageous embodiment, the insert is formed directly on the polymeric main body and, thus, implemented in one piece therewith, with the polymeric main body and the Insert being coextruded. Alternatively, it would also be conceivable to form the insert directly on the polymeric main body, for example, by manufacturing both components together in one two-component injection molding process.

The lateral flanks of the groove can either run parallel to the pane contact surfaces or be inclined in one direction or another. By means of an inclination of the lateral flanks in the direction of the third pane, a taper is produced that can serve to selectively fix the third pane. Furthermore, arched lateral flanks are also conceivable, wherein only the middle section of the lateral flanks makes contact with the third pane. Such arching of the lateral flanks is particularly advantageous in conjunction with a reduced wall thickness d′ of the lateral flanks. The arched lateral flanks have a very good spring effect, in particular with low wall thicknesses. As a result, the flexibility of the lateral flanks is further increased such that thermal expansion of the third pane can be compensated particularly advantageously. In a preferred embodiment, the arched lateral flanks of the pane are made from a different material from the polymeric main body and coextruded therewith. This is particularly advantageous since, thus, the flexibility of the lateral flanks can be selectively increased by the selection of a suitable material, while the stiffness of the polymeric main body is retained.

The polymeric main body preferably has, along the glazing interior surfaces, a total width of 10 mm to 50 mm, particularly preferably of 20 mm to 36 mm. The distance between the first and the third pane or between the third and the second pane is determined by the selection of the width of the glazing interior surfaces. Preferably, the widths of the first glazing interior surface and of the second glazing interior surface are the same. Alternatively, asymmetric spacers are also possible, with the two glazing interior surfaces having different widths. The exact dimensions of the glazing interior surfaces are governed by the dimensions of the insulating glazing unit and the desired sizes of the interpane space.

The polymeric main body preferably has, along the pane contact surfaces, a height of 5 mm to 15 mm, particularly preferably of 5 mm to 10 mm.

The groove preferably has a depth of 1 mm to 15 mm, particularly preferably of 2 mm to 4 mm. Thus, stable fixing of the third pane can be achieved.

The wall thickness d of the polymeric main body is 0.5 mm to 15 mm, preferably 0.5 mm to 10 mm, particularly preferably 0.7 mm to 1 mm.

The lateral surfaces of the web can either run parallel to the first pane and the second pane or be inclined in one direction or another. The height b of the web defines the dimensions of the outer interpane space of the finished insulating glazing unit, since its edge is situated at the same height as the edges of the outer panes. The height b is preferably between 2 mm and 8 mm. The width a of the web preferably matches the width of the groove on the bottom surface, since, thus, particularly good stabilization of the spacer frame is obtained. Even when the width a of the web is greater than the width of the groove, this effect is obtained. The width a of the web is preferably between 1 mm and 10 mm, particularly preferably between 2 mm and 5 mm.

The polymeric main body preferably includes a desiccant, preferably silica gels, molecular sieves. CaCl₂, Na₂SO₄, activated carbon, silicates, bentonites, zeolites, and/or mixtures thereof. The desiccant is preferably incorporated into the main body. Particularly preferably, the desiccant is situated in the first and second hollow chambers of the main body.

In a preferred embodiment, the first glazing interior surface and/or the second glazing interior surface has at least one opening. Preferably, a plurality of openings are made in both glazing interior surfaces. The total number of openings depends on the size of the insulating glazing unit. The openings connect the hollow chambers to the interpane spaces, making a gas exchange between them possible. Thus, absorption of atmospheric moisture by a desiccant situated in the hollow chambers is permitted and, hence, fogging of the panes is prevented. The openings are preferably implemented as slits, particularly preferably as slits with a width of 0.2 mm and a length of 2 mm. The slits ensure optimum air exchange without the desiccant being able to penetrate out of the hollow chambers into the interpane spaces.

The polymeric main body preferably includes polyethylene (PE), polycarbonates (PC), polypropylene (PP), polystyrene, polybutadiene, polynitriles, polyesters, polyurethanes, polymethylmethacrylates, polyacrylates, polyamides, polyethylene terephthalate (PET), polybutylene terephthalate (PBT), preferably acrylonitrile butadiene styrene (ABS), acrylonitrile styrene acrylester (ASA), acrylonitrile butadiene styrene/polycarbonate (ABS/PC), styrene acrylonitrile (SAN), PET/PC, PBT/PC, and/or copolymers or mixtures thereof.

Preferably, the polymeric main body is glass fiber reinforced. The coefficient of thermal expansion of the main body can be varied and adapted by the selection of the glass fiber content in the main body. By adaptation of the coefficient of thermal expansion of the polymeric main body and of the barrier film or barrier coating, temperature-related stresses between the different materials and flaking of the barrier film or barrier coating can be avoided. The main body preferably has a glass fiber content of 20% to 50%, particularly preferably of 30% to 40%. At the same time, the glass fiber content in the polymeric main body improves strength and stability.

In another preferred embodiment, the polymeric main body contains polymers and is filled with hollow glass spheres or glass bubbles. These hollow glass spheres have a diameter of 10 μm to 20 μm and improve the stability of the polymeric main body. Suitable glass spheres are commercially available under the tradename “3M™ Glass Bubbles”. Particularly preferably, the polymeric main body contains polymers, glass fibers, and glass spheres. An admixture of glass spheres results in an improvement of the thermal properties of the spacer.

The web preferably includes polyethylene (PE), polycarbonates (PC), polypropylene (PP), polystyrene, polybutadiene, polynitriles, polyesters, polyurethanes, polymethylmethacrylates, polyacrylates, polyamides, polyethylene terephthalate (PET), polybutylene terephthalate (PBT), preferably acrylonitrile butadiene styrene (ABS), acrylonitrile styrene acrylester (ASA), acrylonitrile butadiene styrene/polycarbonate (ABS/PC), styrene acrylonitrile (SAN), PET/PC, PBT/PC, and/or copolymers or mixtures thereof. Optionally, the web can also be glass fiber reinforced. Particularly preferably, the web is made of the same material as the base material so the web and the polymeric main body have the same coefficient of linear expansion. This contributes to improved stability of the spacer.

The invention further includes an insulating glazing unit with at least a first pane, a second pane and a third pane and a spacer according to the invention arranged circumferentially between the first and the second pane. The first pane contacts the first pane contact surface of the spacer, while the second pane contacts the second pane contact surface. The third pane is inserted into the groove of the spacer. The first pane and the second pane are arranged parallel and congruent. The edges of the two panes are, consequently, arranged flush in the edge region; in other words, they are situated at the same height. The spacer is inserted such that the edge of the web is situated at the same height as the edges of the two panes and is thus arranged flush with them. The web of the spacer thus divides the outer interpane space into two outer interpane spaces, a first outer interpane space and a second outer interpane space. The outer interpane space is defined as the space that is delimited by the first pane, the second pane, and the outer surface of the spacer. The outer interpane spaces are filled with an outer seal. A plastic sealing compound, for example, is used as the outer seal. Since the material of the web has lower thermal conductivity than the outer seal, a thermal separation occurs due to the web. The thermal decoupling results in an improved PSI value (the linear heat transfer coefficient) and, thus, in an improvement of the thermal insulating properties of the edge bond of the insulating glazing unit.

Preferably, the outer seal includes polymers or silane-modified polymers, particularly preferably organic polysulfides, silicones, room-temperature vulcanizing (RTV) silicone rubber, peroxide vulcanizing silicone rubber, and/or addition vulcanizing silicone rubber, polyurethanes, and/or butyl rubber.

At the corners of the insulating glazing unit, the spacers are preferably linked to one another via corner connectors. Such corner connectors can be implemented, for example, as a molded plastic part with a seal, in which two spacers provided with a miter cut abut. In principle, various geometries of the insulating glazing unit are possible, for example, rectangular, trapezoidal, and rounded shapes. To produce round geometries, the spacer according to the invention can be bent, for example, in the heated state.

The panes of the insulating glazing unit are connected to the spacer via a seal. For this, a seal is mounted between the first pane and the first pane contact surface and/or the second pane and the second pane contact surface. The seal includes a polyisobutylene. The polyisobutylene can be a cross-linking or a non-cross-linking polyisobutylene.

The first pane, the second pane, and/or the third pane of the insulating glazing unit preferably include glass and/or polymers, particularly preferably quartz glass, borosilicate glass, soda lime glass, polymethylmethacrylate, and/or mixtures thereof.

The first pane and the second pane have a thickness of 2 mm to 50 mm, preferably 3 mm to 16 mm, with the two panes also possibly having different thicknesses. The third pane has a thickness of 1 mm to 4 mm, preferably of 1 mm to 3 mm, and particularly preferably of 1.5 mm to 3 mm. The spacer according to the invention enables, by means of the tension-free fixing, an advantageous reduction of the thickness of the third pane with unchanged stability of the glazing unit. Preferably, the thickness of the third pane is less than the thicknesses of the first and second pane. In a possible embodiment, the thickness of the first pane is 3 mm, the thickness of the second pane is 4 mm, and the thickness of the third pane is 2 mm. Such an asymmetric combination of the pane thicknesses results in a significant improvement of the acoustic damping.

The insulating glazing unit is filled with a protective gas, preferably with a noble gas, preferably, argon or krypton, which reduce the heat transfer value in the insulating glazing unit interspace.

The third pane of the insulating glazing unit preferably has a low-E coating.

The third pane of the insulating glazing unit is preferably not prestressed. By eliminating the prestressing process, the production costs can be reduced.

In another embodiment, the insulating glazing unit comprises more than three panes. Here, the spacer can include multiple grooves that can accommodate further panes. In this case, one web per spacer can be installed or another web per per groove can be installed below the corresponding groove in each case.

A plurality of panes could also be implemented as composite glass panes.

The invention further includes a method for producing an insulating glazing unit according to the invention comprising the steps:
a) Inserting the third pane into the groove of the spacer,
b) Mounting the first pane on the first pane contact surface of the spacer,
c) Mounting the second pane on the second pane contact surface of the spacer, and
d) Pressing the pane arrangement.

After insertion of the third pane into the groove of the spacer, this preassembled component can be processed in a conventional double glazing system known to the person skilled in the art. The costly Installation of additional system components or a loss of time with multiple passes through the system, as with the use of multiple spacers, can thus be avoided. This is particularly advantageous with regard to productivity gains and cost reduction. Furthermore, even with the use of low-E or other functional coatings on the third pane in accordance with the method according to the invention, no prestressing of the third pane is necessary since the spacer with the insert according to the invention fixes the pane tension-free in its circumference. With the use of a spacer according to the prior art, which accommodates a third pane in a groove, a failure of the seal between the pane contact surfaces and the first and the second pane can occur due to the additional weight of the third pane. This results, during production, in sagging of the spacer frame with a third pane. This sagging or slippage is prevented by the web of the spacer according to the invention, as a result of which otherwise required measures for supporting the frame before and after the pressing of the panes become superfluous. In addition, the embodiment with the web prevents slippage of the spacer frame while the outer seal cures. The production of a triple glazing unit can thus be significantly improved and simplified by the spacer according to the invention.

In a preferred embodiment of the method, the spacer is first preshaped to form a rectangle open on one side. Here, for example, three spacers can be provided with a miter cut and linked at the corners by corner connectors. Instead of this, the spacers can also be directly welded to one another, for example, by ultrasonic welding. The third pane is slid into the groove of the spacer starting from the open side of the arrangement into the spacer arranged U-shaped. The remaining open edge of the third pane is then also closed with a spacer. Optionally, before the assembly of the spacer, an insert can be applied on the pane edges. Thereafter, the processing of the preassembled component is done in accordance with the method according to the invention, wherein, in the next step, the first pane is mounted on the first pane contact surface.

Preferably, the interpane spaces between the first pane and the third pane as well as between the second pane and the third pane are filled with a protective gas before the pressing of the pane arrangement.

Preferably, the outer interpane spaces are filled with an outer seal. Since the entire outer interpane space between the outer panes is divided by the web of the spacer according to the invention into two narrower interpane spaces, the filling can be performed on a standard system for filling triple insulating glazing units. These systems usually use two nozzles, which are in each case guided along between an outer pane and the adjacent middle pane, with the two pane edges serving as a guide. Here, the web of the spacer assumes the function of the middle pane and serves as a guide for the nozzles for filling the outer interpane spaces with the material of the outer seal.

The invention further includes the use of a spacer according to the invention in multiple glazing units, preferably in insulating glazing units, particularly preferably in triple insulating glazing units.

The invention is explained in detail in the following with reference to drawings. The drawings are purely schematic representations and are not true to scale. They in no way restrict the invention. They depict:

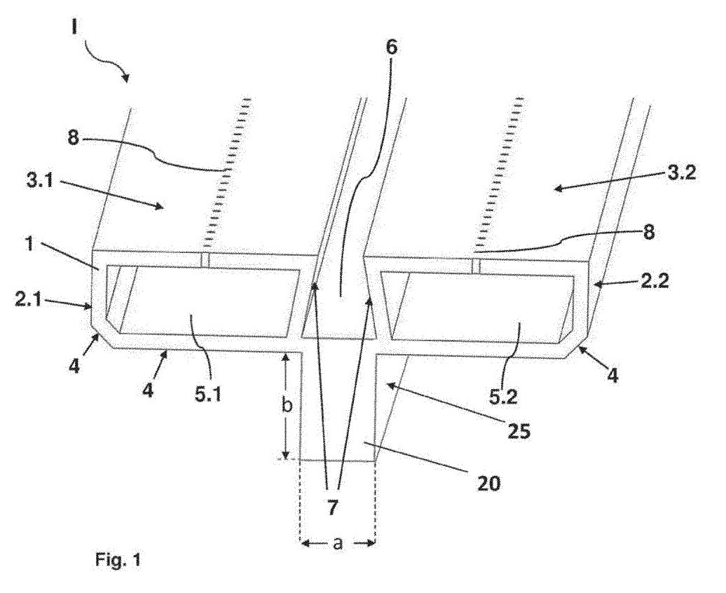

FIG. 1 a possible embodiment of the spacer according to the invention,

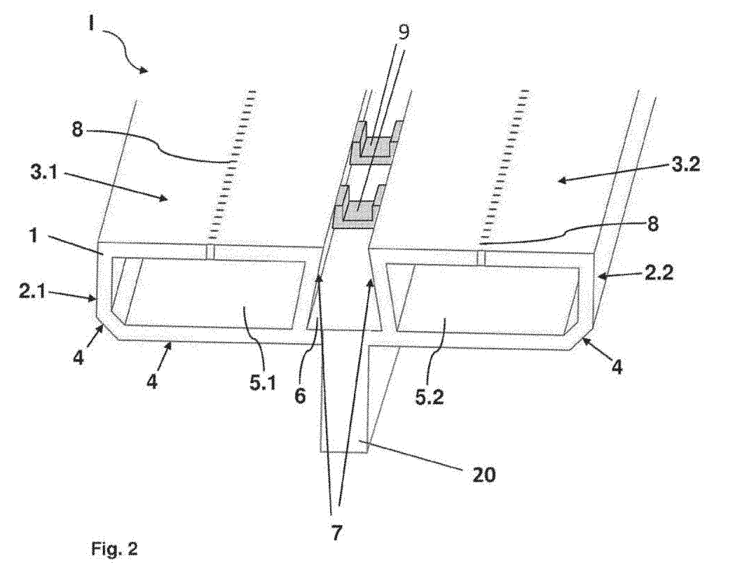

FIG. 2 another possible embodiment of the spacer according to the invention,

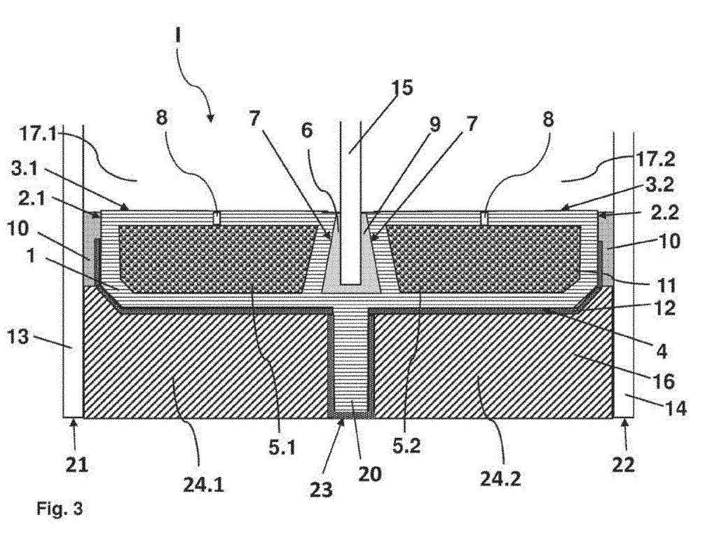

FIG. 3 a cross-section of a possible embodiment of the insulating glazing unit according to the invention,

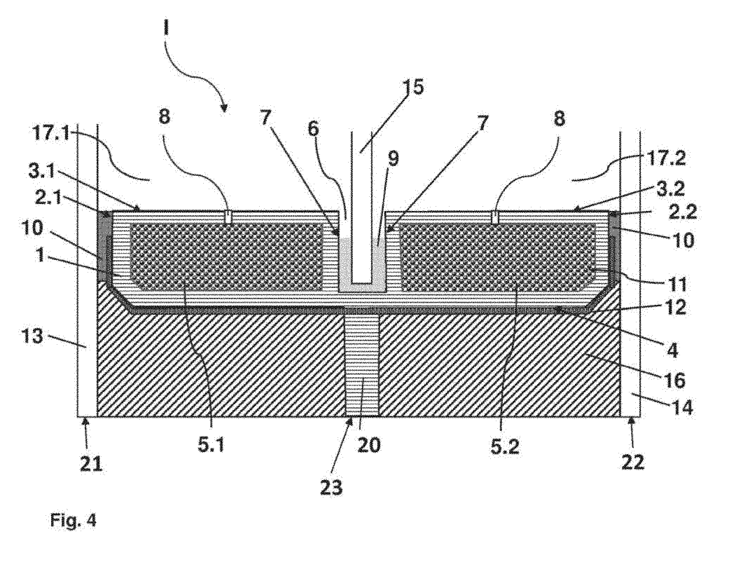

FIG. 4 a cross-section of another possible embodiment of the insulating glazing unit according to the invention,

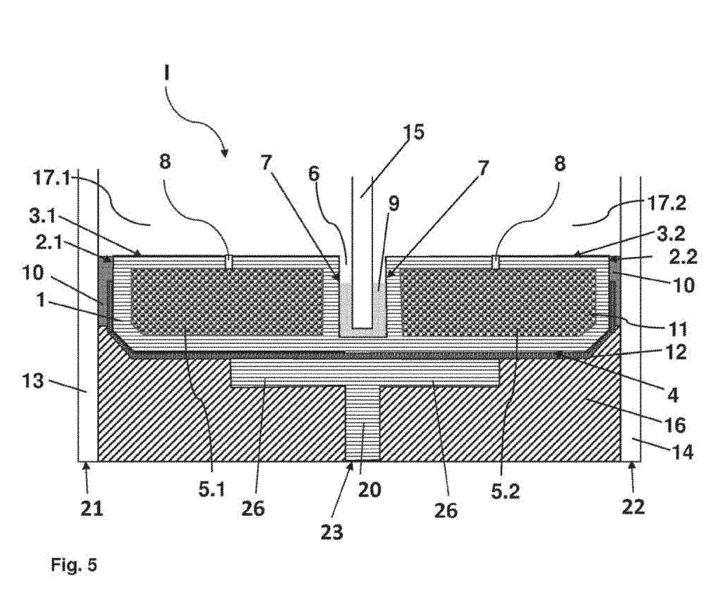

FIG. 5 a cross-section of another possible embodiment of the insulating glazing unit according to the invention, and

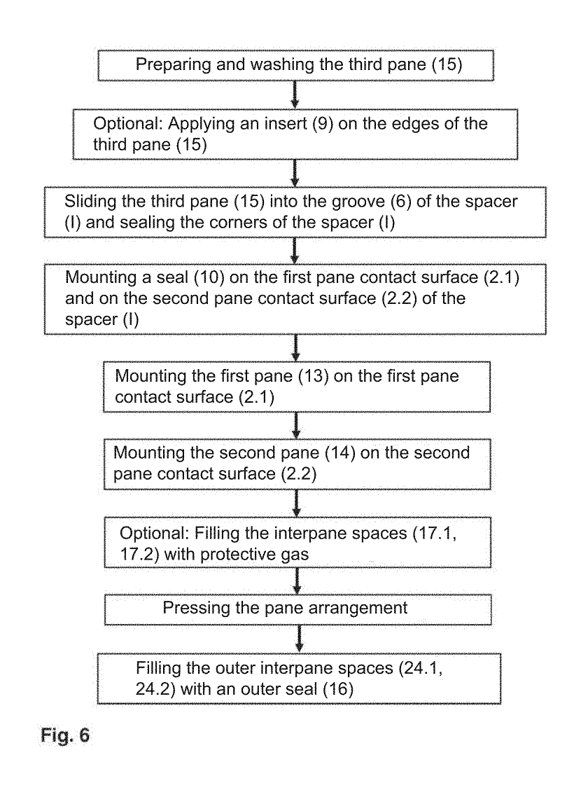

FIG. 6 a flowchart of a possible embodiment of the method according to the invention.

FIG. 1 depicts a cross-section of the spacer I according to the invention. The glass fiber reinforced polymeric main body 1 comprises a first pane contact surface 2.1, a second pane contact surface 2.2 running parallel thereto, a first glazing interior surface 3.1, a second glazing interior surface 3.2, and an outer surface 4. A first hollow chamber 5.1 is situated between the outer surface 4 and the first glazing interior surface 3.1, while a second hollow chamber 5.2 is arranged between the outer surface 4 and the second glazing interior surface 3.2. A groove 6, which runs parallel to the pane contact surfaces 2.1 and 2.2, is situated between the two hollow chambers 5.1 and 5.2. The lateral flanks 7 of the groove 6 are formed by the walls of the two hollow chambers 5.1 and 5.2, while the bottom surface of the groove 6 is adjacent the web. The lateral flanks 7 of the groove 6 are inclined inward in the direction of a pane to be accommodated in the groove 6. Thus, a tapering of the groove 6 is created at the level of the glazing interior surfaces 3.1 and 3.2, which tapering favors the fixing of a pane in the groove 6. The wall thickness d of the polymeric main body is 1 mm, while the reduced wall thickness d′ in the region of the lateral flanks is 0.8 mm. The outer surface 4 runs largely perpendicular to the pane contact surfaces 2.1 and 2.2 and parallel to the glazing interior surfaces 3.1 and 3.2. The sections of the outer surface 4 nearest the pane contact surfaces 2.1 and 2.2 are, however, inclined at an angle of preferably 30° to 60° relative to the outer surface 4 in the direction of the pane contact surfaces 2.1 and 2.2. This angled geometry improves the stability of the polymeric main body 1 and enables better bonding of the spacer I according to the invention to a barrier film. A web 20, which holds the spacer frame in the proper position during the production of the insulated glazing, is mounted below the groove 6. The web 20 is implemented in one piece together with the polymeric main body. The width a of the web 20 corresponds to the width of the groove 6 in the region of the bottom surface and is 3 mm. The height b of the web is 4.5 mm. In the finished insulating glazing unit, the lateral surfaces 25 are in contact with the outer seal 16. The polymeric main body 1 and the web 20 contain styrene acrylonitrile (SAN) with roughly 35 wt.-% glass fiber. The glazing interior surfaces 3.1 and 3.2 have, at regular intervals, openings 8, which connect the hollow chambers 5.1 and 5.2 to the air space above the glazing interior surfaces 3.1 and 3.2. The spacer I has a height of 6.5 mm and a total width of 34 mm. The groove 6 has a depth of 3 mm, while the first glazing interior surface 3.1 is 16 mm wide and the second glazing interior surface 3.2 is 16 mm wide. The total width of the spacer I is the sum of the widths of the glazing interior surfaces 3.1 and 3.2 and the thickness of the third pane 15 with insert 9 to be inserted into the groove 6.

FIG. 2 depicts a cross-section of the spacer I according to the invention. The spacer depicted essentially corresponds to the spacer depicted in FIG. 1. An insert 9 made of butyl is mounted in the groove 6. The insert 9 makes contact with the lateral flanks 7. The insert 9 fixes the pane to be inserted in the groove 6 and prevents development of noise during the opening and closing of the window and compensates thermal expansion of the pane to be inserted during warming. The insert 9 has interruptions, by means of which pressure equalization between adjacent inner interpane spaces 17.1 and 17.2 is enabled after installation of a third pane 15 to be inserted. In the spacer depicted, the width a of the web 20 is somewhat smaller than in FIG. 1 and is only 2 mm, by means of which adequate support is obtained with a savings of material at the same time.

FIG. 3 depicts a cross-section of an insulating glazing unit according to the invention with the spacer I depicted in FIG. 2. The first pane 13 of the triple insulating glazing unit is bonded via a seal 10 to the first pane contact surface 2.1 of the spacer I, while the second pane 14 is bonded via a seal 10 to the second pane contact surface 2.2. The seal 10 is made of a cross-linking polyisobutylene. The lateral flanks 7 of the groove 6 are inclined inward in the direction of the third pane 15. A third pane 15 is inserted into the groove 6 of the spacer via an insert 9. The insert 9 surrounds the edge of the third pane 15 and fits flush into the groove 6. The insert 9 is made of butyl rubber. The insert 9 fixes the third pane 15 without tension and compensates thermal expansion of the pane. Furthermore, the insert 9 prevents development of noise due to slippage of the third pane 15. The intermediate space between the first pane 13 and the third pane 15 delimited by the first glazing interior surface 3.1 is defined here as the first inner interpane space 17.1, and the space between the third pane 15, and the second pane 14 delimited by the second glazing interior surface 3.2 is defined as the second inner interpane space 17.2. Via the openings 8 in the glazing interior surfaces 3.1 and 3.2, the inner interpane spaces 17.1 and 17.2 are connected to the respective underlying hollow chamber 5.1 or 5.2. A desiccant 11 made of a molecular sieve is situated in the hollow chambers 5.1 and 5.2. Through the openings 8, a gas exchange occurs between the hollow chambers 5.1, 5.2 and the interpane spaces 17.1, 17.2, wherein the desiccant 11 extracts the atmospheric humidity from the interpane spaces 17.1 and 17.2. The polymeric main body 1 and the web 20 are implemented in one piece. Thus, a particularly stable connection between the web 20 and the polymeric main body 1 is created. In addition, compared to a two-piece implementation, a production step, namely the gluing-on of the web 20 is eliminated. A barrier 12, which reduces the heat transfer through the polymeric main body 1 into the interpane space 17, is applied on the outer surface 4, which, in this one-piece implementation of the main body 1 and the web 20, also comprises the lateral surfaces 25 and the edge 23 of the web 20. The barrier 12 is implemented as a barrier film 12 and can, for example, be fastened on the polymeric main body 1 with a polyurethane hot melt adhesive. The barrier film 12 comprises four polymeric layers of polyethylene terephthalate with a thickness of 12 μm and three metallic layers made of aluminum with a thickness of 50 nm. The metallic layers and the polymeric layers are alternatingly applied in each case, with the two outer layers being formed by polymeric layers. The first pane 13 and the second pane 14 protrude beyond the pane contact surfaces 2.1 and 2.2 such that an outer interpane space 24 is created, which is divided by the web 20 into a first outer interpane space 24.1 and a second outer interpane space 24.2. The edge 21 of the first pane 13, the edge 22 of the second pane 14, and the edge 23 of the web 20 are arranged at one height. The outer interpane spaces 24.1 und 24.2 are filled with an outer seal 16. This outer seal 16 is formed from an organic polysulfide. The web 20 divides the outer seal 16 into two parts. Since the thermal conductivity of the outer seal 16 is higher than that of the web 20, thermal decoupling occurs, which results in an improvement of the thermal insulation properties of the edge bond. The first pane 13 in the second pane 14 are made of soda lime glass with a thickness of 3 mm, while the third pane 15 is formed from soda lime glass with a thickness of 2 mm.

FIG. 4 depicts a cross-section of an insulating glazing unit according to the invention with a spacer I according to the invention. The insulating glazing unit corresponds essentially to the insulating glazing unit depicted in FIG. 3. The lateral flanks 7 of the groove 6 run, in this case, parallel to the pane contact surfaces 2.1 and 2.2. The insert 9 extends over the entire width of the bottom surface but only partially covers the lateral flanks 7 of the groove 6, by which means material is saved. The polymeric main body 1 and the web 20 are implemented in two pieces. The web 20 is mounted on the barrier film 12 below the groove 6. The web 20 is made of styrene acrylonitrile (SAN) with roughly 35% glass fiber. The web 20 is, for example, fastened with a polyurethane hot melt adhesive. In this two-piece implementation of a polymeric main body 1 and web 20, the web 20 does not additionally have to be provided with the barrier film 12 in order to obtain effective insulating action, by which means the material costs are reduced.

FIG. 5 depicts a cross-section of an insulating glazing unit according to the invention with a spacer I according to the invention. The insulating glazing unit corresponds essentially to the insulating glazing unit depicted in FIG. 4. The web 20 and the polymeric main body 1 are implemented in two pieces. The web 20 is configured as a T-shaped profile. The two side arms 26 of the web 20 increase the stability of the spacer I, since the bonding area with the gas- and vapor-tight barrier 12 is enlarged. The thickness of the side arms is roughly 1 mm. The side arms cover only a part of the outer surface.

FIG. 6 depicts a flowchart of a possible embodiment of the method according to the invention. First, the third pane 15 is prepared and washed. Optionally, an insert 9 is then mounted on the edges of the third pane 15. The third pane 15 is now slid into the groove 6 of the spacer I according to the invention. Here, three spacers I can, for example, be preshaped to form a rectangle open on one side, wherein the third pane 15 is slid into the groove 6 via the open side. Then, the fourth pane edge is closed with a spacer I. The corners of the spacer are either welded or linked to one another via corner connectors. These first three process steps serve to prepare a pane 15 with a spacer I according to the invention. Such a preassembled component can then be further processed in a conventional double glazing system. The assembly of the first pane 13 and the second pane 14 on the pane contact surfaces 2.1 and 2.2 via a seal 10 in each case is done in the double glazing system. Optionally, a protective gas can be introduced into the interpane spaces 17.1 and 17.2. Then, the insulating glazing unit is pressed. In the last step, an outer seal 16 is filled into the outer interpane spaces 24.1 and 24.2, and the finished insulating glazing unit is placed on a rack to dry.

### LIST OF REFERENCE CHARACTERS

I spacer
1 polymeric main body
2 pane contact surfaces
2.1 first pane contact surface
2.2 second pane contact surface
3 glazing interior surfaces
3.1 first glazing interior surface
3.2 second glazing interior surface
4 outer surface
5 hollow chambers
5.1 first hollow chamber
5.2 second hollow chamber
6 groove
7 lateral flanks
8 openings
9 insert
10 seal
11 desiccant
12 barrier/barrier film/barrier coating
13 first pane
14 second pane
15 third pane
16 outer seal
17 inner interpane spaces
17.1 first inner interpane space
17.2 second inner interpane space
20 web
21 edge of the first pane
22 edge of the second pane
23 edge of the web
24 outer interpane space
24.1 first outer interpane space
24.2 second outer interpane space
25 lateral surface of the web
26 side arm of the web
a width of the web
b height of the web

1.-14. (canceled)

15. A spacer for an insulating glazing unit, comprising:
a polymeric main body comprising:
a first pane contact surface;
a second pane contact surface parallel to the first contact surface;
a first glazing interior surface;
a second glazing interior surface;
an outer surface;
a first hollow chamber; and
a second hollow chamber,
wherein:
a groove between the first glazing interior surface and the second glazing interior surface configured to accommodate a pane runs parallel to the first pane contact surface and the second pane contact surface,
the first hollow chamber is adjacent the first glazing interior surface, and the second hollow chamber is adjacent the second glazing interior surface,
lateral flanks of the groove are formed by a wall of the first hollow chamber and a wall of the second hollow chamber, and
a web is arranged directly below the groove on a side of the spacer opposite the groove.

16. The spacer according to claim 15, further comprising a gas- and vapor-tight barrier mounted on the outer surface of the polymeric main body and on at least a part of the first and second pane contact surfaces, wherein the web is mounted on the gas- and vapor-tight barrier.

17. The spacer according to claim 15, further comprising a gas- and vapor-tight barrier, wherein:
the polymeric main body and the web are extruded or coextruded in one piece, and
the gas- and vapor-tight barrier is mounted on:
the outer surface of the polymeric main body,
lateral surfaces of the web,
an edge of the web, and
at least a part of the pane contact surfaces.

18. The spacer according to claim 16, wherein the gas- and vapor-tight barrier is implemented as a film that comprises at least one polymeric layer and at least one of a metallic layer and a ceramic layer.

19. The spacer according to claim 17, wherein the gas- and vapor-tight barrier is implemented as a film that comprises at least one polymeric layer and at least one of a metallic layer and a ceramic layer.

20. The spacer according to claim 18, wherein the film comprises at least two metallic layers and/or ceramic layers, that are arranged alternatingly with at least one polymeric layer.

21. The spacer according to claim 17, wherein the gas- and vapor-tight barrier is implemented as a coating that contains one or more of: a) aluminum, b) aluminum oxides, and c) silicon oxides.

22. The spacer according to claim 21, wherein the coating is applied by a physical vapor deposition (PVD) method.

23. The spacer according to claim 15, wherein an insert is mounted in the groove.

24. The spacer according to claim 23, wherein the insert contains an elastomer.

25. The spacer according to claim 24, wherein the elastomer contains butyl rubber.

26. The spacer according to claim 15, wherein a wall thickness d′ in a region of the lateral flanks is less than a wall thickness d of the polymeric main body.

27. The spacer according to claim 26, wherein d′<0.7*d.

28. The spacer according to claim 26, wherein d′<0.5*d.

29. The spacer according to claim 15, wherein the polymeric main body contains a desiccant.

30. The spacer according to claim 29, wherein the dessicant contains one or more of: a) silica gels, b) molecular sieves, c) CaCl₂, d) Na₂SO₄, e) activated carbon, f) silicates, g) bentonites, and h) zeolites.

31. The spacer according to claim 15, wherein the polymeric main body contains polyethylene (PE), polycarbonates (PC), polypropylene (PP), polystyrene, polybutadiene, polynitriles, polyesters, polyurethanes, polymethylmethacrylates, polyacrylates, polyamides, polyethylene terephthalate (PET), polybutylene terephthalate (PBT), preferably acrylonitrile butadiene styrene (ABS), acrylonitrile styrene acrylester (ASA), acrylonitrile butadiene styrene/polycarbonate (ABS/PC), styrene acrylonitrile (SAN), PET/PC, PBT/PC, and/or copolymers or mixtures thereof.

32. An insulating glazing unit, comprising:
a first pane;
a second pane;
a third pane; and
the spacer according to claim 15,
wherein:
the first pane contacts the first pane contact surface of the spacer,
the second pane contacts the second pane contact surface of the spacer,
the third pane is inserted into the groove of the spacer,
an edge of the first pane, an edge of the second pane, and an edge of the web are arranged flushed so that a space between the first pane and the second pane is divided by the web into a first outer interpane space and a second outer interpane space, and
the first and second outer interpane spaces are filled with an outer seal.

33. The insulating glazing unit according to claim 32, wherein a seal is mounted between one or both of the first pane and the first pane contact surface, and the second pane and the second pane contact surface.

34. The insulating glazing unit according to claim 33, wherein the seal contains a polyisobutylene.

35. A method for producing the insulating glazing unit according to claim 32, the method comprising:
a) inserting the third pane into the groove of the spacer;
b) mounting the first pane on the first pane contact surface of the spacer;
c) mounting the second pane on the second pane contact surface of the spacer; and
d) pressing together a pane arrangement comprising the first pane, the second pane, the third pane, and the spacer.

36. The method according to claim 35, wherein the step a) further comprises: first, preshaping the spacer to form a rectangle that is open on one side; sliding the third pane into the groove of the preshaped spacer; and closing a remaining edge of the third pane with a spacer.

37. A method, comprising using the spacer according to claim 15 in multiple glazing units.

38. The method according to claim 37, wherein the multiple glazing units comprise insulating glazing units.

39. The method according to claim 38, wherein the insulating glazing units comprise triple insulating glazing units.
